(19) United States
(12) Patent Application Publication
(10) Pub. No.: US 2026/0281649 A1
(43) Pub. Date: Sep. 17, 2026

(54) AUDIO SIGNAL PROCESSING METHOD

(71) Applicant: Areal BV, Wuustwezel (BE)

(72) Inventors: Pieter Doms, Wuustwezel (BE); Arno Voortman, Overmere (BE)

(21) Appl. No.: 19/562,390

(22) Filed: Mar. 10, 2026

(30) Foreign Application Priority Data
Mar. 11, 2025 (BE) 2025/5152

(51) Int. Cl. H04S 7/00; H04R 5/04

(52) U.S. Cl. CPC H04S 7/30; H04R 5/04

(57) ABSTRACT

The invention relates to a computer-implemented audio signal processing method for controlling spatial focus in three-dimensional sound.

### RELATED APPLICATION

This Application claims priority under 35 U.S.C. § 119 or 365 to Belgian Patent Application No. BE 2025/5152, filed Mar. 11, 2025. The entire teachings of the above application are incorporated herein by reference.

### FIELD OF THE INVENTION

The invention relates to a computer-implemented audio signal processing method for controlling spatial focus in three-dimensional sound.

### BACKGROUND OF THE INVENTION

Stereo is a 2-dimensional (2D) audio experience, where the user typically receives sounds from the lefthand side and righthand side. In a spatial or 3D sound environment, on the other hand, audio sounds are received from 3 dimensions, typically including left, right, front, back, above, and below. 3D audio delivers a richer, higher quality audio experience which is more natural to users, since it more closely mimics how people listen to sounds in real life. With 3D audio, one can hear multiple sounds or voices occurring at the same time, allowing the listener to pinpoint the direction and distance of the different sound sources or sound objects. 3D audio is typically used in Virtual Reality (VR) projects and games, as well as in some movies having special effects. With 3D audio, a more immersive experience may be created for the listener compared to stereo audio.

In recent years, the demand for immersive audio experiences has significantly increased, particularly with the rise of 3D sound technologies and multi-speaker audio systems. One key aspect of delivering such experiences is the use of upmixing techniques, which expand stereo audio signals into multi-channel or immersive audio layouts. Traditional upmixing methods typically spread sound equally across an immersive layout without considering the directionality or transient characteristics of the sound. This can result in a lack of focus or clarity in the placement of specific audio elements, which diminishes the realism of the immersive audio experience.

Furthermore, existing real-time upmixing systems are typically static and fixed. When upmixing stereo to immersive, localization of sound object is usually lost and becomes spread everywhere. The spread is also not equal everywhere.

Therefore, there is a need for audio processing methods for more precise control over the spatial focus of sound in a 3D space. There is also a need for audio processing methods that allow for a more efficient emphasis on a particular spatial zone in an immersive layout. There is a need for audio processing methods to have an upmixing system that can keep localisation of the original stereo feeling, but also provides an immersive experience.

### SUMMARY OF THE INVENTION

The inventors have surprisingly found that one or more of these problems can be solved by the present invention and (preferred) embodiments thereof.

The present invention relates to an audio signal processing method that isolates the transient regions of a sound and strategically directs them within an immersive audio layout. By manipulating the transients independently of the sustain portion, this method allows for more precisely controlling the spatial focus of sound in a 3D space. For instance, by focusing the transients on the front speakers and diffusing them on the rear speakers, the listener experiences a more natural and focused audio perception, particularly when there is a need to emphasize certain audio zones, such as the front of the soundstage.

Most preferably, the method involves the use of dynamic compression techniques to isolate transients from the original audio signal. Dynamic compressors typically reduce volume when the sound exceeds a certain threshold, with the attack and release parameters controlling the reaction time and duration of the volume attenuation. By using a very fast attack time and a short release time, transients can be efficiently isolated, allowing the sustain portion of the sound to remain unaffected. Additionally, a custom-designed variable threshold compressor may ensure that a constant desired gain reduction (for example a fixed gain reduction in the range of 6 to 16 dB) is obtained from the compressor, regardless of variations in input sound levels. This solution enhances the overall stability and reliability of transient isolation across different audio inputs.

The present invention provides an efficient approach to improving the realism and focus of upmixed audio, leveraging the inherent properties of transients to enhance spatial perception in immersive sound environments.

In a first aspect, the present invention relates to a computer-implemented audio signal processing method for controlling spatial focus in three-dimensional sound. The three-dimensional sound is preferably created by a set of speakers in an immersive audio layout. The method preferably comprises one or more, preferably all, of the steps of:
selecting a first subset of speakers from the set of speakers, wherein the first subset comprises one or more speakers located in a first spatial zone of the immersive audio layout;
providing an input audio signal, the input audio signal corresponding to an original signal, or the input audio signal resulting from upmixing an original signal;
processing the input audio signal, comprising:
   isolating a transient region from the input audio signal, resulting in an isolated transient signal;
   adding the isolated transient signal to the input audio signal, resulting in a transient-enriched signal; and,
using the transient-enriched signal to define a first output audio signal, to be sent to the first subset of speakers.

This allows to create three-dimensional sound with a controlled spatial focus on the first spatial zone, in particular an enhanced spatial focus on the first spatial zone. Thus, it allows to enhance spatial localisation of the audio signal on the first subset of speakers. In some embodiments, the first output audio signal is sent to the first subset of speakers.

In some preferred embodiments, the method is integrated in an overall upmixing method.

In some preferred embodiments, the step of isolating a transient region from the input audio signal comprises:
producing a transient-limited signal, herein also referred to as a duplicated signal, by removing a transient region from the input audio signal;
polarity-reversing the transient-limited signal; and,
adding the reversed transient-limited signal to the input audio signal, thereby obtaining the isolated transient signal.

In some preferred embodiments, the method further comprises the steps of:
selecting a second subset of speakers from the set of speakers, wherein the second subset comprises one or more speakers located in a second spatial zone of the immersive audio layout, different from the first spatial zone; and,
using the transient-limited signal to define a second output audio signal, to be sent to the second subset of speakers.

In some embodiments, the first output audio signal is sent to the first subset of speakers.

In some preferred embodiments, the transient region is removed from the input audio signal by applying dynamic compression to the input audio signal, preferably using a dynamic compressor configured to apply a volume attenuation.

In some preferred embodiments, the dynamic compressor is operated with an attack time of at most 5.0 ms, preferably an attack time of at least 0.0 ms to at most 1.0 ms, and a release time of at most 100.0 ms, preferably a release time of at least 10.0 ms to at most 30.0 ms.

In some preferred embodiments, the dynamic compressor is operated with a ratio ranging from 20:1 to infinity: 1 ratio, to function as a limiter for removing the transient region from the input audio signal.

In some preferred embodiments, the method further comprises the step of:
adjusting a threshold of the dynamic compressor using a variable threshold, preferably based on the root mean square (RMS) level of the incoming audio signal.

In some preferred embodiments, the dynamic compressor maintains a constant gain reduction, for example a constant gain reduction in the range of from 6 dB to 16 dB, for example a constant gain reduction of 6 dB or of 10 dB, independent of variations in the level of the input audio signal.

In some preferred embodiments, the first subset of speakers comprises front speakers of the immersive audio layout.

In some preferred embodiments, the second subset of speakers comprises rear speakers of the immersive audio layout.

In a second aspect, the present invention relates to an audio signal processing system for processing audio signals in an immersive audio layout. (Preferred) embodiments of the first aspect are also (preferred) embodiments of the second aspect, and vice versa. Preferably, the system of the second aspect is configured to perform the method of the first aspect, and (preferred) embodiments thereof. Preferably, the method of the first aspect is performed with the system of the second aspect, and (preferred) embodiments thereof.

The system preferably comprises one or more, preferably all, of the components of:
an input channel for receiving an input audio signal, the input audio signal corresponding to an original signal, or the input audio signal resulting from upmixing an original signal;
an isolating module configured to produce an isolated transient signal, by isolating a transient region from the input audio signal;
a combining module configured to produce a transient-enriched signal, by adding the isolated transient signal to the input audio signal; and,
a routing module configured to direct the transient-enriched signal to a first subset of speakers, the first subset selected from the set of speakers and comprising one or more speakers located in a first spatial zone of the immersive audio layout.

In some preferred embodiments, the isolating module comprises a dynamic compressor, configured to remove a transient region from the input audio signal. In some preferred embodiments, the isolating module is configured to:
produce a transient-limited signal from the input audio signal, by means of the dynamic compressor;
polarity-reverse the transient-limited signal; and,
produce the isolated transient signal by adding the reversed transient-limited signal to the input audio signal.

In some preferred embodiments, the dynamic compressor includes a variable threshold controlled by an RMS detector, configured to obtain a transient-limited signal with a constant gain reduction, independent of variations in the level of the input audio signal.

In a third aspect, the present invention relates to use of the method according to the first aspect, and (preferred) embodiments thereof, and/or of the system according to the second aspect, and (preferred) embodiments thereof, in a live setting.

(Preferred) embodiments of the first aspect are also (preferred) embodiments of the second or third aspect, and vice versa.

### BRIEF DESCRIPTION OF THE FIGURES

FIG. 1 illustrates two audio signals. The top signal illustrates the input audio signal showing the original transient. The bottom signal illustrates the transient-limited signal wherein transients are compressed.

FIG. 2 illustrates a compressor with a variable threshold, configured to be used according to an embodiment of the invention.

### DETAILED DESCRIPTION OF THE INVENTION

The present invention will be described with respect to particular embodiments; the invention is not limited thereto but only by the claims. Any reference signs in the claims shall not be construed as limiting the scope thereof.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements, or method steps. The terms “comprising”, “comprises” and “comprised of” when referring to recited members, elements or method steps also include embodiments which “consist of” said recited members, elements, or method steps.

Furthermore, the terms first, second, third, and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The term “about” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” refers is itself also specifically, and preferably, disclosed.

The recitation of numerical ranges by endpoints includes all numbers and fractions subsumed within the respective ranges, as well as the recited endpoints. All documents cited in the present specification are hereby incorporated by reference in their entirety. Unless otherwise defined, all terms used in disclosing the invention, including technical and scientific terms have the meaning as commonly understood by one of the ordinary skill in the art to which this invention belongs.

By means of further guidance, definitions for the terms used in the description are included to better appreciate the teaching of the present invention. The terms or definitions used herein are provided solely to aid in the understanding of the invention. Reference throughout this specification to “one embodiment” or “an embodiment” means that a particular feature, structure, or characteristic described in connection with the embodiment is included in at least one embodiment of the present invention.

Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the following claims and description, any of the claimed or described embodiments can be used in any combination.

In a first aspect, the present invention relates to a computer-implemented audio signal processing method for controlling spatial focus in three-dimensional sound. The three-dimensional sound is preferably created by a set of speakers in an immersive audio layout. The method preferably comprises one or more, preferably all, of the steps of:
selecting a first subset of speakers from the set of speakers, wherein the first subset comprises one or more speakers located in a first spatial zone of the immersive audio layout;
providing an input audio signal, the input audio signal corresponding to an original signal, or the input audio signal resulting from upmixing an original signal;
processing the input audio signal, comprising:
   isolating a transient region from the input audio signal, resulting in an isolated transient signal;
   adding the isolated transient signal to the input audio signal, resulting in a transient-enriched signal; and,
using the transient-enriched signal to define a first output audio signal, to be sent to the first subset of speakers.

This allows to create three-dimensional sound with a controlled spatial focus on the first spatial zone. In some preferred embodiments, the first output audio signal is sent to the first subset of speakers.

As used herein, the terms “3D environment” or “3D space” are used interchangeably, and refer to an immersive soundscape, as opposed to stereo which has a left-to-right soundscape. The term “3D environment” may also be referred to as an “immersive audio environment” or an “immersive audio layout”. As used herein, the term “three-dimensional sound” refers to sound produced in a 3D environment.

In 3D sound processing, the following terms may be used relating to typically time-dependent variables, herein collectively referred to as “dynamic properties”:
The term “gain” refers to the volume level or amplification of a sound.
The term “reverb” refers to the simulation of the reflection and reverberation of sound in a physical environment.
The term “spread” refers to the width of sound sources in a 3D space, and how far the sound is dispersed from its original location.
The term “position” refers to the location of a sound source in a 3D space, and can be used to create a sense of spatial orientation and movement of sound in a virtual environment.

As used herein, the terms “speaker” and “loudspeaker” are used interchangeably, and refer to an element adapted to produce sound. As used herein, the term “set of speakers” refers to two or more, preferably 6 or more speakers. As used herein, the term “subset of speakers” refers to a selection of speakers from the “set of speakers”. A subset of speakers comprises one or more speakers. The first subset comprises one or more speakers located in a first spatial zone of the immersive audio layout. A “spatial zone” refers to a portion of the 3D space, wherein one speaker or a group of speakers is found. For example, the first spatial zone may be a frontal zone in the immersive audio layout, wherein a group of front speakers is located. For example, a second spatial zone may be a rear zone in the immersive audio layout, wherein a group of read speakers is located. Alternatively, the first spatial zone may be a rear zone in the immersive audio layout, wherein a group of rear speakers is located, and the second spatial zone may be a frontal zone in the immersive audio layout, wherein a group of front speakers is located.

In some preferred embodiments, the method is integrated in an overall upmixing method. As used herein, the term “upmixing” refers to the process of generating additional speaker signals from an original sound signal with fewer channels than available speakers. For example, a stereo signal, containing two signals, may be upmixed to obtain multiple channel signals, the amount of obtained channel signals being larger than two. In other words, in this example, upmixing implies converting the original two-channel signal into multi-channel surround formats.

In some preferred embodiments, first a classical upmixing may be applied to an original signal, resulting in multiple different channel signals. For a particular speaker, first the appropriate channel signal may be selected, and subsequently used as an input audio signal for further processing. In this case, the input audio signal corresponds to the signal obtained after performing classical upmixing.

In other preferred embodiments, no preceding classical upmixing is performed. In this case, the original signal, being the same for every speaker, is used as input audio signal for further processing.

As used herein, the term “transient” refers to the first vibrations of a sound. The opposite of the transient region of a sound is the “sustain” region. Sustain are the vibrations which can be heard after the transient. The amount of transients define the character of a sound. For example, drums usually have a high amount of transients while the stroke of a violin snare has fewer transients. These initial burst of energy at the onset of a sound play a critical role in how the human brain perceives the directionality of audio sources. Transients, such as the sharp initial strike of a drum or the pluck of a string, provide essential cues for spatial localization. In contrast, the sustain portion of a sound, which follows the transient, has less impact on spatial perception. However, current upmixing technologies do not fully utilize the potential of transients to enhance the localization of sound.

The human brain tends to use transients to locate the direction of a sound when a sound has a lot of transients. The inventors have found that the technique of steering transients towards speakers in a specific spatial zone may be used to create a more trustworthy upmixing experience.

The aim in 3D sound experiences, is to be able to experience a more realistic hearing experience due to the possibility to create, e.g., a moving effect of the sound. For instance, a sound may me experienced as being moved from the left side to the right side, as would be the case when an object would be passing behind a person from the left to the right. By selectively steering different subsets of speakers to focus on the transient regime, this type of hearing experience may be improved.

The inventors have found that a three-dimensional sound with an enhanced spatial focus on a first spatial zone may be obtained by first processing the input audio signal to obtain a transient-enriched signal, and subsequently using the transient-enriched signal to define a first output audio signal. In particular, the transient-enriched signal is obtained by first isolating a transient region from the input audio signal, and next adding the isolated transient signal to the input audio signal. The transient-enriched signal is thus a signal wherein the transient portion is strengthened or intensified compared to the input audio signal. Afterwards, the transient-enriched signal may be used to produce a first output audio signal, wherein the first output audio signal is sent to the speakers of the first subset. In some embodiments, the first output audio signal may correspond to the transient-enriched signal itself, or the first output audio signal may be obtained from the transient-enriched signal after further signal processing.

This allows to create three-dimensional sound with a controlled spatial focus on the first spatial zone, in particular an enhanced spatial focus on the first spatial zone. Thus, it allows to enhance spatial localisation of the audio signal on the first subset of speakers. Moreover, as the transient-enriched signal is created by adding a transient to an original input signal, it becomes possible to obtain an altered output for an existing channel. Advantageously, it thus allows to enhance spatial information in the sound for an already available channel or speaker, without needing any additional channels or speakers. Furthermore, this approach allows to freely control the total sound strength, of the total mix of signals, e.g. by simultaneously compensating at another channel or speaker.

Speaker configurations and choices to which the transients may be sent are unlimited as such. Dolby Atmos may be as a standard. Placement of transients (i.e., the placement of the focus) is a creative choice, and can theoretically be positioned anywhere.

In some embodiments, the isolated transients may be focussed to the first subset of speakers, whereas for other speakers in the immersive layout, the transient content is not altered. In other embodiments, apart from adding transients for the first subset of speakers, the transient content may also be reduced for other speakers in the layout. This has been found to keep the balance and helps to focus on the first spatial zone.

In some preferred embodiments, the step of isolating the transient region from the input audio signal comprises the steps of:
producing a transient-limited signal by removing a transient region from the input audio signal;
polarity-reversing the transient-limited signal; and,
adding the reversed transient-limited signal to the input audio signal, thereby obtaining the isolated transient signal.

Transient isolation is thus performed by first producing a transient-limited signal. The transient-limited signal is a signal wherein the transient content is reduced or weakened compared to the input audio signal. In other words, the transient-limited signal is a duplicate of the input audio signal wherein the transients are removed completely or to a large extent. The transient-limited signal may thus be referred to as the ‘duplicated signal’. Once a duplicate of the sound with all transients removed is obtained, polarity reversal may be applied. The reversed signal may then be summed to the input audio signal. With the gains matched this will result in a cancelation of the full signal, except for the difference between the sounds. In this case, the difference will be the transient being present in the input audio signal and being removed in the duplicated sound.

In some preferred embodiments, the isolated transient signal is added to the input audio signal according to an adjustable volume level. Different volume levels may thus be applied, thereby allowing to increase the transient content of the signal according to a desired degree.

In some preferred embodiments, the method further comprises the steps of:
selecting a second subset of speakers from the set of speakers, wherein the second subset comprises one or more speakers located in a second spatial zone of the immersive audio layout, different from the first spatial zone; and,
using the transient-limited signal to define a second output audio signal, to be sent to the second subset of speakers.

The second subset of speakers comprises one or more speakers located in a second spatial zone of the immersive audio layout. The “second spatial zone” refers to a portion of the 3D space wherein one speaker or a group of speakers is found, wherein the second spatial zone differs from the first spatial zone. For example, the first spatial zone may be a frontal zone in the immersive audio layout, wherein a group of front speakers is located, and the second spatial zone may be a rear zone in the immersive audio layout, wherein a group of rear speakers is found. The first and the second subsets of speakers do not comprise any mutual speakers. Preferably, the two subsets of speakers add up to the full set of speakers. Alternatively, the two subsets of speakers do not amount to the full set of speakers. In some preferred embodiments, the first subset of speakers and the second subset of speakers comprise the same number of speakers.

The transient-limited signal is a duplicate signal wherein transients have been reduced or removed compared to the input audio signal. The transient-limited signal may be used to produce a second output audio signal, wherein the second output audio signal is sent to the speakers of the second subset. In some embodiments, the second output audio signal may correspond to the transient-limited signal itself, or the second output audio signal may be obtained from the transient-limited signal after further signal processing.

In this way, transients are not only added with respect to the first subset of speakers, but are equally removed with respect to the second subset of speakers. In other words, the isolated transients are focussed to the first subset of speakers, and are diffused on the second subset speakers This allows to balance the audio signal distribution, and helps to focus to the first spatial zone. Moreover, this approach allows to optimally control the total sound strength, of the total mix of signals, wherein signal portions added at one channel or speaker are compensated at another channel or speaker.

In some preferred embodiments, the first subset of speakers comprises front speakers of the immersive audio layout, and/or the second subset of speakers comprises rear speakers of the immersive audio layout.

The isolated transients are thus focussed to the front speakers, and are diffused on the rear speakers. This thereby creates a forward spatial focus.

In some preferred embodiments, the transient region is removed from the input audio signal by applying dynamic compression to the input audio signal. Preferably a dynamic compressor is used for this purpose, wherein the dynamic compressor is configured to apply a volume attenuation.

A dynamic compressor applies a volume reduction when a sound crosses a predetermined threshold. The compressor may have several variable controls to modify for example the reaction time and the amount of volume attenuation that is applied. These controllers are called attack and ratio. Another controller found at a dynamic compressor is the release. This controller defines how long it takes for the volume attenuation to return to zero when the level lowers back below the threshold value. Using these parameters, the present invention allows to remove a transient region from the input audio signal, in view of producing a transient-limited signal.

In stereo, a “dynamic compressor” is typically used to give every part of the music its specific place in the mix. A dynamic compressor is a device which limits the dynamic range of a specific piece of the mix. Therefore, the gain of an audio source may be compressed during a specific period of time to balance out too much noise and not enough volume, or vice versa. Gain is the unit of measurement for the loudness of an audio source and is typically measured in decibels (dB). Although existing dynamic compressors and dynamic expanders are typically used with surround sound, a dynamic compressor and/or a dynamic expander can also be used to create a 3D sound experience.

The terms “attack zone” and “release zone” are often used in reference to audio compression and dynamic range processing, where the attack and release settings determine how quickly the gain of the sound is reduced or increased in response to the audio signal.

For transient isolation, the true first peaks of each sound are preferably captured. Therefore a very fast attack time is preferred, for example an attack time of at most 2.0 ms, preferably at most 1.0 ms, for example in a range of 0.1 ms to 1.0 ms.

Since the sustain region of a sound remains preferably untouched, a relatively short release time is preferred. In some preferred embodiments, the release time is from at least 10.0 ms too at most 30.0 ms.

In some preferred embodiments, the dynamic compressor has an attack time of at least 0.0 ms to at most 1.0 ms and/or a release time of at least 10.0 ms to at most 30.0 ms.

The preferred values of attack and release are very short in comparison to the general use of a dynamic compressor. Normally, depending on the sound being processed, one would use an attack of 5-30 ms and a release of 100-400 ms. The goal of the present invention, however, is to remove the transient of the sound as much as possible.

Preferably, the transient is removed as much as possible to create the biggest difference between original and duplicated sound as possible. To obtain this, a very high ratio on the compressor is preferred. Most compressors have the infinity ratio mode. This will result in the compressor acting as a limiter and provides the best result. In some preferred embodiments, the dynamic compressor operates with a ratio ranging from 20:1 to infinity:1 ratio, to function as a limiter for removing the transient region from the input audio signal.

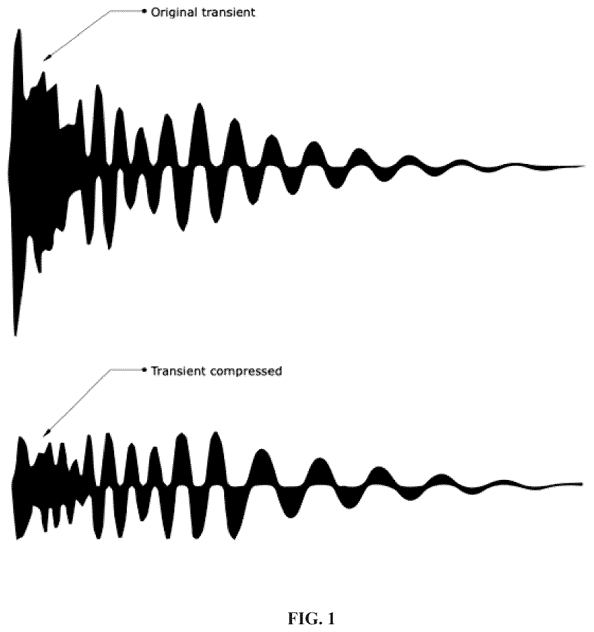

FIG. 1 illustrates two audio signals. The top signal illustrates the input audio signal showing the original transient. The bottom signal illustrates the signal obtained after applying dynamic compression, thus a duplicate signal wherein the transient is compressed. The bottom signal thus corresponds to a transient-limited signal, i.e. a signal wherein a transient region was removed from the input audio signal.

Once the transient-limited signal is obtained via dynamic compression of the input audio signal, an isolated transient may be obtained by polarity reversing the transient-limited signal and adding it to the input audio signal. Once transients are isolated, they can be steered into a direction. A creative choice would be to focus the transients to the front speakers. The isolated transients are then preferably added to the input audio signal going to the front speakers. However, this would typically result in basically adding a fixed value (for example 6 dB) of the original signal in the above mentioned set up. Therefore, in a preferred embodiment, if transients have been added to one subset of speakers (for example the front), they are preferably equally removed from a second subset of speakers (for example the rear speakers). This allows to maintain the balance and assists the focus on the first subset of speakers.

Since the method already results in a signal with the transients removed, i.e. the transient-limited signal, the latter is preferably sent to the second subset of speakers. Preferably, this signal has the same polarity as the signal provided to the first subset of speakers.

In some preferred embodiments, the method further comprises the step of:
adjusting a threshold of the dynamic compressor using a variable threshold, preferably based on the root mean square (RMS) level of the incoming audio signal.

In some preferred embodiments, the RMS level may be calculated over an averaging period of 2 seconds to modify the threshold of the dynamic compressor.

In some preferred embodiments, the dynamic compressor maintains a constant gain reduction, for example a constant gain reduction in the range of from 6 dB to 16 dB, for example a constant gain reduction of 6 dB or of 10 dB, independent of the variations in the level of the input audio signal.

When a “threshold” value is exceeded, it is referred to as “threshold crossing” or “going over the threshold”. In audio processing, threshold values are used in dynamic range processing tools, such as compressors, to determine the level at which a specific effect should be applied to an audio signal. Preferably, the threshold is related to the gain (volume level) of the sound object. Typical ranges of threshold are −60 dB up to +20 dB.

As used herein, the term “dynamic range” refers to the difference between the loudest and softest parts of an audio signal. It is usually measured in decibels (dB) and represents the range between the highest and lowest sound levels in a recording or performance. The dynamic range of an audio object is an important factor that affects the perceived quality and overall impact of the sound, and can be influenced by various factors including recording techniques, mixing, and mastering. A larger dynamic range allows for more detail and nuance in the audio signal, while a smaller dynamic range can make the sound seem more compressed and uniform.

After tests, it was found that the transient isolation works best when setting the compressor threshold at a certain level, preferably so that it results in a fixed gain reduction (for example a gain reduction in the range from 6 dB to 16 dB). Unfortunately, not all sounds have the same level. Since the threshold is set to a fixed value, there is no guarantee that the gain reduction will always be the desired fixed gain reduction, for example 6 dB.

To solve this problem a compressor that has a variable threshold is preferably used. The threshold preferably follows the average level of the signal fed in to it. This average is advantageously calculated by using an RMS detector. Such detector averages the sound, for example in a range of at least 1 second to at most 10 seconds, for example about 2 seconds. This average may then be used to modify the value of the threshold of the compressor. By doing this, the gain reduction can always be fixed, for example at 6 dB. Since RMS is an average, the peaks of the transients have no influence, making it ideal for constant gain reduction on the transients. This type of compressor is newly developed especially for this purpose, while traditional compressors are designed to work from a certain level, not to have a constant gain reduction.

In this way, a consistent gain reduction of the transient region is obtained.

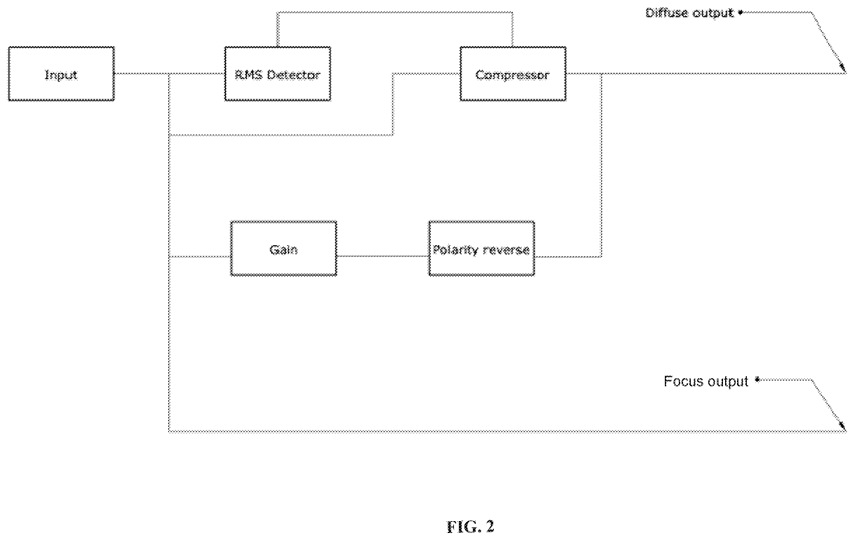

FIG. 2 illustrates a compressor with a variable threshold, configured to be used according to an embodiment of the invention.

In a second aspect, the present invention relates to an audio signal processing system for processing audio signals in an immersive audio layout. (Preferred) embodiments of the first aspect are also (preferred) embodiments of the second aspect, and vice versa. Preferably, the system of the second aspect is configured to perform the method of the first aspect, and (preferred) embodiments thereof. Preferably, the method of the first aspect is performed with the system of the second aspect, and (preferred) embodiments thereof.

The system preferably comprises one or more, preferably all, of the components of:
an input channel for receiving an input audio signal, the input audio signal corresponding to an original signal, or the input audio signal resulting from upmixing an original signal;
an isolating module configured to produce an isolated transient signal, by isolating a transient region from the input audio signal;
a combining module configured to produce a transient-enriched signal, by adding the isolated transient signal to the input audio signal; and,
a routing module configured to direct the transient-enriched signal to a first subset of speakers, the first subset selected from the set of speakers and comprising one or more speakers located in a first spatial zone of the immersive audio layout.

In some preferred embodiments, the combining module is configured to add the isolated transient signal according to an adjustable volume level.

In some preferred embodiments, the isolating module is configured to:

produce a transient-limited signal from the input audio signal, by removing a transient region from the input audio signal;
polarity-reverse the transient-limited signal; and,
produce the isolated transient signal by adding the reversed transient-limited signal to the input audio signal.

In some preferred embodiments, the routing module is configured to direct the transient-limited signal to a second subset of speakers, the second subset selected from the set of speakers and comprising one or more speakers located in a second spatial zone of the immersive audio layout.

In some preferred embodiments, the first subset of speakers comprises front speakers of the immersive audio layout and/or the second subset of speakers comprises rear speakers of the immersive audio layout. In this way, the routing module is configured to focus the transients to the first subset of speakers, e.g. the front speakers, and to diffuse the transients on the second subset of speakers, e.g. the rear speakers. This allows to balance the audio signal distribution and to create a forward spatial focus in the immersive audio layout.

In some preferred embodiments, the isolating module comprises a dynamic compressor, configured to remove a transient region from the input audio signal.

In some preferred embodiments, the dynamic compressor is configured to be operated with:
an attack time of 0.0 to 1.0 ms;
a release time of 10.0 to 30.0 ms; and/or,
a ratio set in a range from 20:1 to infinity:1 to maximize transient attenuation; and,

In this way, the dynamic compressor may be operated with a small attack time, thereby allowing to capture the transient region of the signal, and with a small release time, thereby avoiding affecting the sustain region. Furthermore, the dynamic compressor may be operated with a high ratio, to maximize transient attenuation.

In some preferred embodiments, the dynamic compressor includes a variable threshold controlled by an RMS detector, configured to obtain a transient-limited signal with a constant gain reduction, independent of variations in the level of the input audio signal.

In some preferred embodiments, the compressor maintains a constant gain reduction based on the RMS level of the input signal preferably a constant gain reduction in the range of from 6 dB to 16 dB, for example a constant gain reduction of 6 dB or of 10 dB.

In a third aspect, the present invention relates to use of the method according to the first aspect, and (preferred) embodiments thereof, and/or of the system according to the second aspect, and (preferred) embodiments thereof, in a live setting. The present methods and system of the present invention are particularly suitable for real-time processing, and are therefore particularly suitable for use in a live setting.

(Preferred) embodiments of the first or second aspect are also (preferred) embodiments of the third aspect, and vice versa.

The invention may be computer-implemented for studio mixing purposes. In this case, it could, for example, be provided as a plugin (VST) for a DAW system, or could form a part of a DAW system. In the live or broadcast sector, it could be implemented as a part of the processing in a live immersive mixing desk.

In some preferred embodiments, the method performs the adjustments in real-time. In some preferred embodiments, the mixing tool is configured to be operated in real-time.

In the context of computer processing, a method that is performed “in real-time” refers to a process that occurs as fast as it is needed, with minimal or no delay. In order for an audio process to be considered real-time, it must be able to complete within a predetermined timeframe, known as the “latency.” The latency of a real-time process is typically measured in milliseconds or microseconds, and it must be small enough to meet the requirements of the application. For example, in a real-time audio processing system, the latency must be small enough to ensure that the processed audio is played back in sync with the original audio, without any noticeable delay. Preferably the latency is at most 20.0 ms, for example at most 10.0 ms. When working live, the latency is preferably at most 2.0 ms, more preferably at most 1.0 ms.

Real-time processing requires a combination of fast hardware and efficient software algorithms in order to meet the strict latency requirements. The present invention has the advantage that the method is efficient enough to be performed in real-time. In some embodiments, the method is a computer-implemented method. In some embodiments, one or more steps of the method are performed by a computer. In some embodiments, all steps of the method are performed by a computer.

In some embodiments, the amount of transients that is added, is variable. For example, the amount of transients that is added may range from −6 dB to +18 dB.

The invention also relates to a system or device, such as a data processing apparatus, comprising means for carrying out one or more steps, for example all steps, of the method according to the first aspect of the invention, and (preferred) embodiments thereof. The system or device may comprise different hardware and/or software aspects to provide the functionalities as illustrated. For example, the system or device may comprise a computer, a computing system, or a processor, e.g., a general-purpose computing platform specifically programmed, e.g., by a suitable executable code, for implementing all or some elements described herein. In embodiments, the system or device may operate as a standalone device or may be connected, e.g., networked, to other machines in a networked deployment.

The invention also relates to a computer program product directly loadable into the internal memory of a computer, or a computer program product stored on a computer readable medium, or a combination of such computer programs or computer program products, configured for performing a computer-implemented method according to the first aspect of the invention, and (preferred) embodiments thereof.

The invention also relates to a computer program product comprising instructions which, when the program is executed by a computer, cause the computer to carry out one or more steps, for example all steps, of the method according to the first aspect of the invention, and (preferred) embodiments thereof. The invention also relates to a computer-readable medium comprising instructions which, when executed by a computer, cause the computer to carry out one or more steps, for example all steps, of the method according to the first aspect of the invention, and (preferred) embodiments thereof.

What is claimed is:

1. A computer-implemented audio signal processing method for controlling spatial focus in three-dimensional sound, wherein the three-dimensional sound is created by a set of speakers in an immersive audio layout, the method comprising:
selecting a first subset of speakers from the set of speakers, wherein the first subset comprises one or more speakers located in a first spatial zone of the immersive audio layout;
providing an input audio signal, the input audio signal corresponding to an original signal, or the input audio signal resulting from upmixing an original signal;
processing the input audio signal, comprising
isolating a transient region from the input audio signal, resulting in an isolated transient signal; and
adding the isolated transient signal to the input audio signal, resulting in a transient-enriched signal; and
using the transient-enriched signal to define a first output audio signal, to be sent to the first subset of speakers;
thereby allowing for controlled spatial focus on the first spatial zone in the three-dimensional sound.

2. The method according to claim 1, wherein isolating the transient region from the input audio signal comprises:
producing a transient-limited signal by removing the transient region from the input audio signal;
polarity-reversing the transient-limited signal; and
adding the reversed transient-limited signal to the input audio signal, thereby obtaining the isolated transient signal.

3. The method according to claim 2, wherein the method further comprises:
selecting a second subset of speakers from the set of speakers, wherein the second subset comprises one or more speakers located in a second spatial zone of the immersive audio layout, different from the first spatial zone; and
using the transient-limited signal to define a second output audio signal, to be sent to the second subset of speakers.

4. The method according to claim 2, wherein the transient region is removed from the input audio signal by applying dynamic compression to the input audio signal.

5. The method according to claim 4, wherein applying the dynamic compression to the input audio signal uses a dynamic compressor configured to apply a volume attenuation.

6. The method according to claim 5, wherein the dynamic compressor is operated with an attack time of at most 5.0 ms, and a release time of at most 100.0 ms.

7. The method according to claim 5, wherein the dynamic compressor is operated with a ratio ranging from 20:1 to infinity:1, to function as a limiter for removing the transient region from the input audio signal.

8. The method according to claim 5, further comprising:
adjusting a threshold of the dynamic compressor using a variable threshold.

9. The method according to claim 5, wherein the dynamic compressor maintains a constant gain reduction, independent of variations in the level of the input audio signal.

10. The method according to claim 1, wherein the first subset of speakers comprises front speakers of the immersive audio layout.

11. The method according to claim 3, wherein the second subset of speakers comprises rear speakers of the immersive audio layout.

12. An audio signal processing system for processing audio signals in an immersive audio layout, the system comprising:
an input channel for receiving an input audio signal, the input audio signal corresponding to an original signal, or the input audio signal resulting from upmixing the original signal;
an isolating module configured to produce an isolated transient signal, by isolating a transient region from the input audio signal;
a combining module configured to produce a transient-enriched signal, by adding the isolated transient signal to the input audio signal; and
a routing module configured to direct the transient-enriched signal to a first subset of speakers, the first subset comprising one or more speakers located in a first spatial zone of the immersive audio layout.

13. The system according to claim 12, wherein the isolating module comprises a dynamic compressor configured to remove a transient region from the input audio signal, and wherein the isolating module is further configured to:
produce a transient-limited signal from the input audio signal, by means of the dynamic compressor;
polarity-reverse the transient-limited signal; and
produce the isolated transient signal by adding the reversed transient-limited signal to the input audio signal.

14. The system according to claim 13, wherein the dynamic compressor includes a variable threshold controlled by a root mean square (RMS) detector configured to obtain a transient-limited signal with a constant gain reduction, independent of variations in a level of the input audio signal.

15. The system according to claim 12, configured for carrying out the method according to claim 1.

16. The method according to claim 1, wherein the method is performed in a live setting.

17. A method of using the system according to claim 12 in a live setting.
